(19) United States
(12) Patent Application Publication
(10) Pub. No.: US 2012/0135653 A1
(43) Pub. Date: May 31, 2012

(54) ISLAND-IN-SEA FIBER, ARTIFICIAL LEATHER AND METHODS FOR PRODUCING THE SAME

(75) Inventors: Yeong Nam Hwang, Gumi-si (KR); Won Jun Kim, Gumi-si (KR); Jong Ho Park, Gumi-si (KR)

(73) Assignee: KOLON INDUSTRIES, INC., Kwacheon-si, Kyunggi-do (KR)

(21) Appl. No.: 13/376,105

(22) PCT Filed: Jun. 3, 2010
(86) PCT No.: PCT/KR10/03577

§ 371 Date: Feb. 14, 2012

(30) Foreign Application Priority Data
Jun. 4, 2009 (KR) 10-2009-0049582
Jun. 29, 2009 (KR) 10-2009-0058426

(51) Int. Cl. B32B 27/04; B32B 5/02; D01D 5/22; B44C 1/22; D02G 3/00

(52) U.S. Cl. 442/60; 216/7; 442/106; 428/373; 264/168

(57) ABSTRACT

Disclosed is an artificial leather containing a non-woven fabric composed of ultra micro fibers and impregnated with an polymeric elastomer, wherein a residual shrinkage ratio of the artificial leather at 30% stretching is 10% or less in a machine direction and is 20% or less in a cross-machine direction. The artificial leather has optimal residual shrinkage ratios, and specifically a residual shrinkage ratio in a machine direction of 10% or less and a residual shrinkage ratio in a cross-machine direction of 20% or less, when the artificial leather is stretched by 30%. As a result, the artificial leather which has stretched during the process for shape-formation can easily contract and restore, and thus avoid creasing even when applied to the products having many curved parts.

### TECHNICAL FIELD

The present invention relates to an artificial leather. More specifically, the present invention relates to an artificial leather which has an optimum elongation and thus avoids creasing during the process for shape-formation thereof.

### BACKGROUND ART

An artificial leather is prepared by impregnating a polymeric elastomer into a non-woven fabric in which ultra micro fibers three-dimensionally bridge. Artificial leather has a soft texture and unique appearance comparable to natural leathers, thus being widely utilized in a variety of applications including shoes, clothes, gloves, fashion accessories, furniture and automobile components.

Such artificial leather requires improved functionality in terms of flexibility, surface quality, abrasion resistance, light fastness, or elongation depending on intended application. Among the functionalities required for artificial leathers, elongation is particularly necessary for products with a curved part. The reason for this is that when artificial leathers having a low elongation are used for products with a curved part, the artificial leathers readily crease during the process for shape-formation thereof.

For examples, among internal components for automobiles, great creases are present in headliners adhered to the automobile ceiling depending on the shape of the automobile body. When artificial leathers having a low elongation are used for automobile headliners, product quality is disadvantageously deteriorated due to the creases occurring in artificial leathers during the process for shape-formation. Accordingly, artificial leathers for products with curved parts such as automobile headliners require a high elongation.

Also, although artificial leathers exhibit a high elongation, when the artificial leathers excessively stretch, they do not contract and disadvantageously crease after the shape-formation.

That is, artificial leathers for products with curved parts should exhibit a high elongation, the elongation should be optimized such that the artificial leathers do not excessively stretch during the process for shape-formation and the artificial leathers should not crease through controlled contraction after the shape-formation. However, disadvantageously, conventionally developed artificial leathers exhibit a low elongation, or excessively stretch during the process for shape-formation in spite of superior elongation properties and thus crease.

For example, in the process of manufacturing artificial leathers, a part of fibers constituting non-woven fabrics are eluted for fibrillation of the fibers of the non-woven fabrics. In conventional cases, scrims are adhered to non-woven fabrics in order to impart form-stability to the non-woven fabrics during the fibrillation process. In this case, final artificial leather products disadvantageously have a considerably low elongation property.

In addition, in an attempt to solve this problem, a method in which scrims are not adhered to non-woven fabrics has been suggested. In this case, there is a problem in which non-woven fabrics are seriously deformed in a machine direction (MD) and a cross-machine direction (CMD) during the fibrillation process. This phenomenon will be described in more detail with reference to the annexed drawing.

FIG. 1 is a schematic view illustrating a conventional apparatus for eluting a part of fibers constituting a non-woven fabric for fibrillation of the fibers without adhering scrims to a non-woven fabric.

As shown in FIG. 1, in a conventional case, a non-woven fabric is fed in a continuous manner into a tank 20 containing a solvent 10 to allow fibers constituting the non-woven fabric 1 to be dissolved in the solvent 10 and then eluted. However, in this case, while the non-woven fabric 1 is continuously moved from one direction to another direction through a plurality of rollers 30, high tension is applied to the non-woven fabric, thus disadvantageously causing serious deformation of the non-woven fabric in a machine direction (MD) and a cross-machine direction (CMD).

### DISCLOSURE

### Technical Problem

Therefore, the present invention has been made in view of the above problems, and it is one object of the present invention to provide an artificial leather which avoids creasing during the process for shape-formation when applied to products having many curved parts and a method for producing the same.

It is another object of the present invention to provide an island-in-sea fiber used for the production of the artificial leather and a method for producing the same.

### Technical Solution

Accordingly, in accordance with one aspect of the present invention, provided is an artificial leather comprising a non-woven fabric composed of ultra micro fibers and impregnated with an polymeric elastomer, wherein a residual shrinkage ratio of the artificial leather at 30% stretching is 10% or less in a machine direction (MD) and is 20% or less in a cross-machine direction (CMD).

The residual shrinkage ratio of the artificial leather at 40% stretching may be 13% or less in a machine direction (MD) and may be 25% or less in a cross-machine direction (CMD).

An elongation of the artificial leather upon 5 kg of static loading may be 20 to 40% in a machine direction (MD) and may be 40 to 80% in a cross-machine direction (CMD).

The artificial leather may have a crystallinity of 25 to 33%.

The polymeric elastomer may be present in an amount of 15 to 35% by weight.

The ultra micro fiber may contain polyethylene terephthalate, polytrimethylene terephthalate or polybutylene terephthalate, and the polymeric elastomer may contain polyurethane.

The ultra micro fiber may have a fineness of 0.3 denier or less.

In accordance with another aspect of the present invention, provided is a method for producing an artificial leather, including: preparing an island-in-sea fiber consisting of a first polymer and a second polymer that have different dissolution properties with respect to a solvent; producing a non-woven fabric with the island-in-sea fiber; immersing the non-woven fabric in a polymeric elastomer solution to impregnate the polymeric elastomer in the non-woven fabric; and removing the first polymer, i.e., sea component, from the non-woven fabric by elution, wherein the removing the first polymer includes rotating the non-woven fabric while immersing a part of the non-woven fabric in a predetermined amount of solvent contained in a tank and not immersing the remainder of the non-woven fabric in the solvent.

The rotating the non-woven fabric may include rotating one or more rollers on which the non-woven fabric is wound and during the rotation, a part of the non-woven fabric immersed in the solvent does not contact the roller. The rollers may include a driving roller driven by a driving member and a guide roller to guide rotation of the non-woven fabric, wherein the non-woven fabric rotates and first contacts the driving roller, when the non-woven fabric moves from a state of being immersed in a solvent to a state of not being immersed in a solvent. The roller may rotate at a rotation rate of 70 m/min to 110 m/min.

The preparing the island-in-sea fiber may include: preparing filaments consisting of a first polymer as a sea component and a second polymer as an island component that have different dissolution properties with respect to a solvent through conjugate spinning; drawing a tow, a bundle of the filaments, at a drawing ratio of 2.5 to 3.3; and mounting a crimp on the drawn tow and heat-setting the tow by heating at a predetermined temperature.

The heat-setting may be carried out at a temperature not lower than 15° C. and not higher than 40° C., when the tow is drawn at a drawing ratio not lower than 2.5 and not higher than 2.7, the heat-setting is carried out at a temperature higher than 40° C. and not higher than 50° C., when the tow is drawn at a drawing ratio higher than 2.7 and not higher than 3.0, and the heat-setting is carried out at a temperature higher than 50° C. and not higher than 60° C., when the tow is drawn at a drawing ratio higher than 3.0 and not higher than 3.3.

The removing the non-woven fabric may be carried out before or after impregnating the polymeric elastomer in the non-woven fabric.

In accordance with another aspect of the present invention, provided is an island-in-sea fiber consisting of a first polymer as a sea component and a second polymer as an island component, wherein the first polymer and the second polymer have different dissolution properties with respect to a solvent and the island-in-sea fiber has an elongation of 90 to 150%.

The island-in-sea fiber may have a crystallinity of 23 to 31%.

The first polymer may contain a polyester copolymer and the second polymer may contain polyethylene terephthalate, polytrimethylene terephthalate, or polybutylene terephthalate.

The first polymer may be present in an amount of 10 to 60% by weight and the second polymer is present in an amount of 40 to 90% by weight.

In accordance with another aspect of the present invention, provided is a method for preparing an island-in-sea fiber including: preparing filaments consisting of a first polymer as a sea component and a second polymer as an island component that have different dissolution properties with respect to a solvent through conjugate spinning; drawing a tow, a bundle of the filaments, at a drawing ratio of 2.5 to 3.3; and mounting a crimp on the drawn tow and heat-setting the tow by heating at a predetermined temperature.

The heat-setting may be carried out at a temperature not lower than 15° C. and not higher than 40° C., when the tow is drawn at a drawing ratio not lower than 2.5 and not higher than 2.7, the heat-setting is carried out at a temperature higher than 40° C. and not higher than 50° C., when the tow is drawn at a drawing ratio higher than 2.7 and not higher than 3.0, and the heat-setting is carried out at a temperature higher than 50° C. and not higher than 60° C., when the tow is drawn at a drawing ratio higher than 3.0 and not higher than 3.3.

### Advantageous Effects

The present invention has the following effects.

The present invention optimizes residual shrinkage ratios of an artificial leather, and specifically optimizes a residual shrinkage ratio of the artificial leather at 30% stretching to 10% or less in a machine direction (MD) and to 20% or less in a cross-machine direction (CMD). As a result, the artificial leather which has stretched during the process for shape-formation can easily contract/restore and can thus prevent creasing even when applied to products having many curved parts. In addition, the present invention optimizes an elongation of artificial leather, and specifically, optimizes an elongation of artificial leather upon 5 kg of static loading to 20 to 40% in a machine direction (MD) and to 40 to 80% in a cross-machine direction (CMD), thus preventing creasing during the process for shape-formation. In addition, the present invention optimizes a crystallinity of artificial leather, specifically optimizes a crystallinity to 25 to 33%, thus preventing deterioration in strength, optimizing elongation properties and facilitating a shape-formation process. Accordingly, the artificial leather according to the present invention is useful for products having many curved parts such as automobile headliners.

### DESCRIPTION OF DRAWINGS

The above and other objects, features and other advantages of the present invention will be more clearly understood from the following detailed description taken in conjunction with the accompanying drawings, in which:

FIG. 1 is a schematic view illustrating a conventional batch-type apparatus for eluting a part of fibers constituting a non-woven fabric to obtain ultra micro fibers from the fibers; and

FIG. 2 is a schematic view illustrating a batch-type apparatus for eluting a sea component to obtain ultra micro fibers from the fibers constituting a non-woven fabric according to the present invention.

### BEST MODE

Hereinafter, preferred embodiments of the present invention will be described in more detail.

### 1. ARTIFICIAL LEATHER

The artificial leather according to the present invention is prepared by impregnating a polymeric elastomer in a non-woven fabric composed of ultra micro fibers.

The polymeric elastomer may be polyurethane and specific examples thereof include, but are not particularly limited to, polycarbonate diol, polyester diol, polyether diol and combinations thereof.

The polymeric elastomer readily stretches. For this reason, by increasing the content of the polymeric elastomer, elongation of artificial leather can be improved. However, when the polymeric elastomer content excessively increases, creases may occur due to excessive stretching during the process for shape-formation. Accordingly, in order to obtain artificial leathers exhibiting optimal elongation, it is necessary to optimize the content of polymeric elastomers. The artificial leather according to the present invention contains 15 to 35% by weight of the polymeric elastomer, more preferably 20 to 30% by weight. When the polymeric elastomer is present in an amount lower than 15% by weight, desired elongation cannot be obtained, and when the polymeric elastomer exceeds 35% by weight, artificial leathers crease during the process for shape-formation.

The non-woven fabric may be composed of nylon or polyester ultra micro fibers and specific examples of the ultra micro fibers include polyethylene terephthalate (PET), polytrimethylene terephthalate (PTT), polybutylene terephthalate (PBT) and the like. The ultra micro fibers constituting the non-woven fabric preferably have a fineness of 0.3 denier or less in terms of improvement in texture of artificial leathers.

When the artificial leather stretches in a predetermined ratio and is then allowed to stand, the artificial leather contracts and returns to the state prior to stretching. The value which indicates a variation percentage (hereinafter, referred to as “variation between before and after stretching”) between the original artificial leather prior to stretching (hereinafter, referred to as “artificial leather before stretching”) and the artificial leather after stretching and then being allowed to stand until it does not contract any more (hereinafter, referred to as “artificial leather after stretching”) is referred to as a residual shrinkage ratio. In order to realize reliability of data, the term “artificial leather after stretching” is defined as an artificial leather which is stretched to a predetermined length in a machine direction (MD), maintained for 10 minutes, un-stretched and allowed to stand for one hour. Specifically, the residual shrinkage ratio upon A % stretching is calculated in accordance with the following equation 1:

Residual shrinkage ratio upon A % stretching=[(L₂−L₁)/L₁]×100 Equation 1

(wherein L₁ represents a length in machine direction (MD) of an artificial leather before stretching and L₂ represents a length (MD) of the artificial leather after A % stretching)

For example, where a length (MD) of 55 cm is obtained right after an artificial leather sample having a length (MD) of 50 cm is stretched by 20% such that the length (MD) is adjusted to 60 cm, maintained for 10 minutes, un-stretched, and allowed to stand for one hour, the residual shrinkage ratio in a machine direction after 20% stretching is obtained by [(55−50)/50]×100=10%.

Accordingly, if residual shrinkage ratio is high, it might be said that the variation between before and after stretching is relatively large, restoration after stretching is insufficient, and the creases may readily occur during the process for shape-formation. To the contrary, if residual shrinkage ratio is low, it might be said that the variation between before and after stretching is relatively small, restoration after stretching is sufficient, and the occurrence of creases during the process for shape-formation can be prevented.

A residual shrinkage ratio upon 30% stretching of the artificial leather according to the present invention is 10% or less in a machine direction and is 20% or less in a cross-machine direction. When the residual shrinkage ratio is within this range, the possibility of creasing is low during the process for shape-formation and the artificial leather may be applied to products having a curved part. In addition, a residual shrinkage ratio upon 40% stretching of the artificial leather according to the present invention is 13% or less in a machine direction and is 25% or less in a cross-machine direction. That is, there is no great difference between the residual shrinkage ratio upon 40% stretching and the residual shrinkage ratio upon 30% stretching.

In addition, preferably, an elongation of the artificial leather according to the present invention upon 5 kg of a static loading is 20 to 40% in a machine direction and is 40 to 80% in a cross-machine direction. When the longitudinal elongation is lower than 20% or the transverse elongation is lower than 40%, properties of the elongation are deteriorated and creases may occur during the process for shape-formation, and when the longitudinal elongation is higher than 40% or the transverse elongation is higher than 80%, the artificial leather excessively stretches and thus creases during the process for shape-formation.

In addition, preferably, the artificial leather according to the present invention has a crystallinity of 25 to 33%. When the crystallinity of the artificial leather exceeds 33%, elongation is deteriorated and creases may occur during the process for shape-formation, and when the crystallinity of the artificial leather is lower than 25%, strength is deteriorated and the artificial leather may excessively stretch and crease during the process for shape-formation.

The artificial leather according to the present invention can be obtained by preparing island-in-sea fibers through a conjugate spinning process, producing a non-woven fabric with the island-in-sea fibers, impregnating a polymeric elastomer into the non-woven fabric, and removing the sea component and micronizing the fibers. The artificial leather can be obtained by producing a non-woven fabric with island-in-sea fibers, removing the sea component from the non-woven fabric and micronizing the fibers, and impregnating a polymeric elastomer into the micronized non-woven fabric.

### 2. ISLAND-IN-SEA FIBER

The island-in-sea fiber according to the present invention consists of a first polymer and a second polymer, which differ in terms of dissolution properties with respect to a solvent.

The first polymer is a sea component which is dissolved in a solvent and thus eluted, which may be composed of a polyester, polystyrene or polyethylene copolymer or the like and is preferably composed of a polyester copolymer which exhibits superior solubility in aqueous alkaline solutions.

The polyester copolymer may be a copolymer of polyethylene terephthalate as a main component with polyethylene glycol, polypropylene glycol, 1-4-cyclohexane dicarboxylic acid, 1-4-cyclohexane dimethanol, 1-4-cyclohexane dicarboxylate, 2-2-dimethyl-1,3-propanediol, 2-2-dimethyl-1,4-butanediol, 2,2,4-trimethyl-1,3-propanediol, adipic acid, a metal sulfonate-containing ester unit or a mixture thereof, but is not limited thereto.

The second polymer is an island component which is not dissolved in a solvent and remains, and may be composed of polyethylene terephthalate (PET) or polytrimethylene terephthalate (PTT) which is not dissolved in an aqueous alkaline solution. In particular, the polytrimethylene terephthalate has a number of carbon atoms which is intermediate between polyethylene terephthalate and polybutylene terephthalate, has elastic recovery comparable to polyamide and exhibits considerably superior alkali resistance and is thus suitable for use as an island component.

The first polymer as a sea component is dissolved and thus eluted in a solvent during a subsequent process and only the second polymer is thus left as an island component. Then, ultra micro fibers are obtained from the island-in-sea fibers according to the present invention. Accordingly, in order to obtain desired ultra micro fibers, it is necessary to suitably control the contents of the first polymer as the sea component and the second polymer as the island component.

Specifically, it is preferable that the first polymer, that is, the sea component, is present in an amount of 10 to 60% by weight in an island-in-sea fiber and the second polymer, that is, the island component, is present in an amount of 40 to 90% by weight. When the sea component (the first polymer) is present in an amount lower than 10% by weight, the content of the island component (second polymer) increases and formation of ultra micro fibers may be impossible. When the sea component (first polymer) is present in an amount higher than 60% by weight, the amount of first polymer removed by elution increases and production costs thus increase. In addition, observing the cross-section of the island-in-sea fibers, 10 or more second polymers as island components are separated and aligned, the first polymers as sea components are eluted, and, as a result, the second polymers as island components have a fineness of 0.3 denier or less, preferably 0.005 to 0.25 denier in terms of improvement in texture of ultra micro fibers.

The island-in-sea fibers according to the present invention are used in combination with a polymeric elastomer for preparation of artificial leathers. The properties of island-in-sea fibers affect properties of final artificial leather products.

Specifically, when taking into consideration the fact that the polymeric elastomer is present in an amount of 15 to 35% by weight in the artificial leather, elongation of the island-in-sea fibers is preferably in a range of 90 to 150%, more preferably, in a range of 110 to 140%. The reason for this is that, when the elongation of the island-in-sea fibers is lower than 90%, artificial leathers with a high elongation cannot be obtained and when the elongation of the island-in-sea fiber is higher than 150%, the strength of the artificial leather is deteriorated and the artificial leather may crease during the process for shape-formation.

In addition, the crystallinity of the island-in-sea fibers is preferably 23 to 31%.

The island-in-sea fibers according to the present invention which satisfy the elongation and crystallinity ranges defined above can be obtained by controlling a drawing ratio during a preparation process. That is, the island-in-sea fibers according to the present invention can be obtained by preparing filaments using the first polymer and the second polymer by conjugate spinning and drawing the filaments. At this time, by controlling a drawing ratio during the drawing process, the island-in-sea fibers which satisfy the elongation and crystallinity ranges can be obtained.

More specifically, a drawing process is a process for applying tensile force to a fiber by controlling the rate of a front roller to be higher than that of a rear roller. At this time, a ratio of a rate of the front roller to a rate of the rear roller is referred to as a “drawing ratio”. In the present invention, by adjusting the drawing ratio to 2.5 to 3.3, an island-in-sea fiber which satisfies the elongation range of 90 to 150% and the crystallinity range of 23 to 31% can be obtained. When the drawing ratio is higher than 3.3, the elongation of the obtained island-in-sea fiber may be lower than 90% and the crystallinity thereof may be higher than 31%, and when the drawing ratio is lower than 2.5, the elongation of the obtained island-in-sea fiber is higher than 150% and the crystallinity thereof may be lower than 23%.

### 3. ISLAND-IN-SEA FIBER AND METHOD FOR PRODUCING THE SAME

A method for producing an island-in-sea fiber according to the present invention according to one embodiment of the present invention will be described.

First, a molten solution of the first polymer as the sea component and a molten solution of the second polymer as the island component were prepared and conjugate spinning was performed by ejecting the molten solution through a predetermined spinneret to prepare a filament.

Then, the filament was bundled to obtain a tow and the tow was drawn. At this time, the rates of the front and rear rollers are controlled such that the drawing ratio is within 2.5 to 3.3.

Then, a plurality of crimps is formed on the drawn tow and is heat-set by heating at a predetermined temperature. At this time, the crimps are preferably provided at a density of 8 to 15/inch. In addition, the heat-setting is preferably carried out by controlling the heating temperature, taking into consideration the drawing ratio during the previous process, that is, the drawing process. Specifically, when the drawing ratio is adjusted to a level not lower than 2.5 and not higher than 2.7, the heat-setting temperature is preferably not lower than 15° C. and not higher than 40° C. When the drawing ratio is adjusted to a level higher than 2.7 and not higher than 3.0, the heat-setting temperature is preferably higher than 40° C. and not higher than 50° C. When the drawing ratio is controlled to a level higher than 3.0 and not higher than 3.3, the heat-setting temperature is preferably higher than 50° C. and not higher than 60° C.

The reason for changing heat-setting temperature ranges depending on the drawing ratio is that, as drawing ratio decreases, crystallinity is deteriorated and thermal properties (in particular, heat resistance) of the drawn tow are deteriorated, and in a case in which the heat-setting temperature is not preferred, island-in-sea fibers may disadvantageously aggregate in the tow.

Then, the heat-set tow is cut to prepare a staple fiber.

At this time, the staple fiber is preferably cut such that the length of the staple fiber is 20 mm or more. The reason for this is that when the length of the staple fiber is below 20 mm, a carding process may be difficult during preparation of the non-woven fabric for production of artificial leathers.

A method for producing an artificial leather according to the present invention according to one embodiment will be described.

First, an island-in-sea fiber was prepared in accordance with the procedure mentioned above.

Then, a non-woven fabric was prepared using the island-in-sea fiber.

The non-woven fabric is prepared by carding and cross-lapping the staple-type island-in-sea fiber to form a web and producing the non-woven fabric using a needle punch.

During the cross-lapping process, a cross-lapped sheet is formed by folding about 20 to about 40 webs.

Preparation of the Non-Woven Fabric is not Limited to the method above and may be carried out by spun-bonding long fibers such as filaments to form a web and producing a non-woven fabric using a needle punch, water jet punch or the like.

Then, a polymeric elastomer is impregnated into the non-woven fabric.

This process includes preparing a polymeric elastomer solution and immersing the non-woven fabric in the polymeric elastomer solution. The polymeric elastomer solution can be prepared by dissolving or dispersing polyurethane in a predetermined solvent. For example, the polymeric elastomer solution can be prepared by dissolving or dispersing polyurethane in dimethyl formamide (DMF) or water as a solvent. Alternatively, a silicone polymeric elastomer may be directly used without dissolving or dispersing the polymeric elastomer in a solvent.

In addition, the polymeric elastomer solution may further contain a pigment, a photo-stabilizing agent, an antioxidant, a flame retardant, a softening agent, a coloring agent or the like.

The non-woven fabric may be subjected to padding using an aqueous polyvinyl alcohol solution to stabilize the shape thereof before it is immersed in the polymeric elastomer solution.

The non-woven fabric is immersed in a polymeric elastomer solution and the non-woven fabric-impregnated polymeric elastomer is coagulated in a coagulation bath and is then washed with water in a washing bath. At this time, the polymeric elastomer solution is obtained by dissolving polyurethane in dimethylformamide as a solvent, the coagulation bath is formed using a mixture of water and a small amount of dimethylformamide and the polymeric elastomer coagulates in the coagulation bath to allow dimethylformamide contained in the non-woven fabric to be released into the coagulation bath. In the water-washing bath, polyvinyl alcohol padded on the non-woven fabric and residual dimethylformamide are removed from the non-woven fabric.

Then, the sea component is removed from the polymeric elastomer-impregnated non-woven fabric and the fiber is micronized.

In this process, the first polymer as the sea component is eluted using an aqueous alkaline solution such as an aqueous sodium hydroxide solution, and as a result, the second polymer, as the island component remains alone and the fiber constituting the non-woven fabric is micronized.

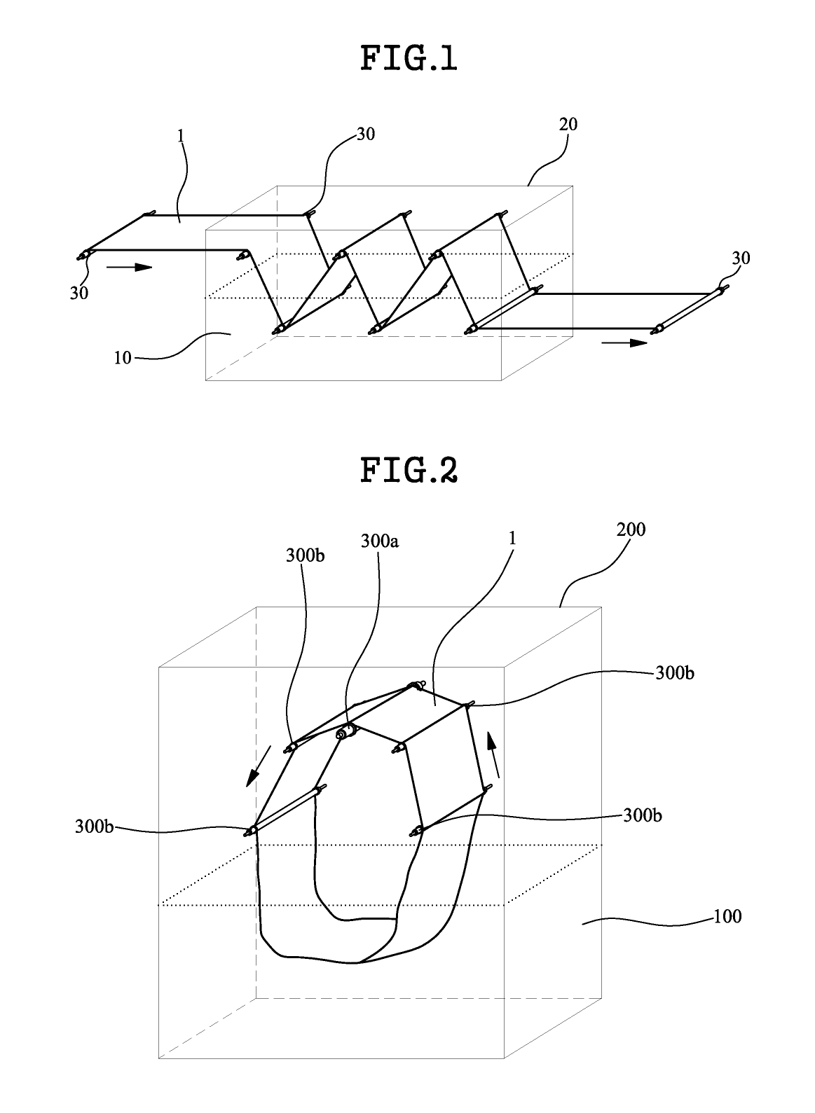

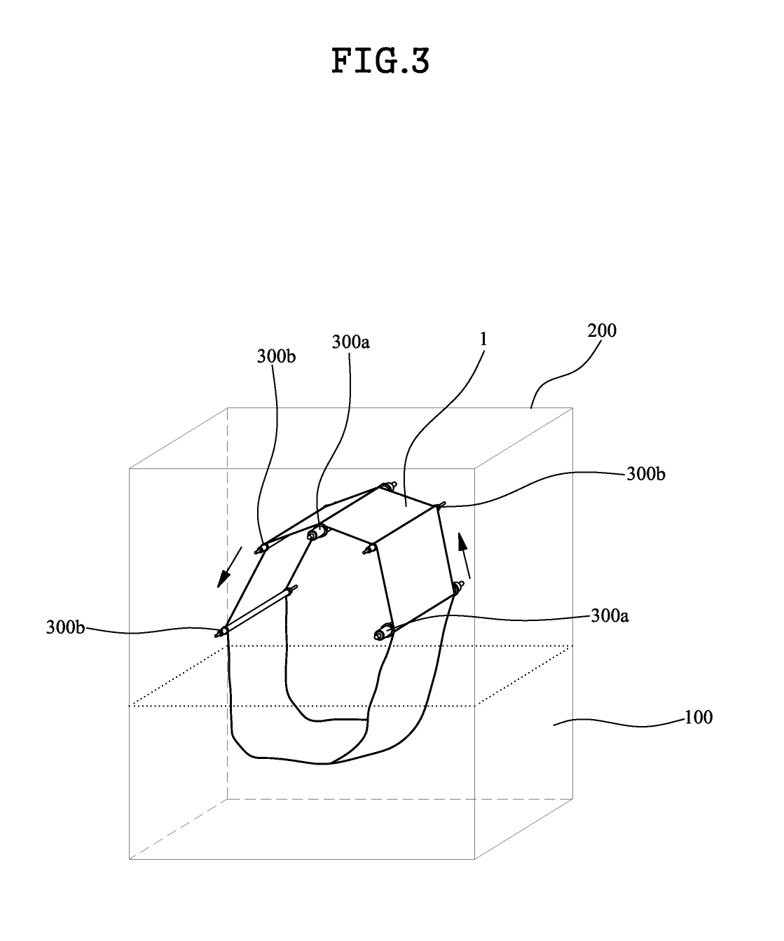

Such a process is preferably carried out in a batch manner as shown in FIG. 2 or 3. That is, when the elusion process is performed in a continuous manner as shown in FIG. 1, high tension is applied to the non-woven fabric, and an artificial leather which satisfies the desired elongation, residual shrinkage ratio and crystallinity properties cannot be obtained. Accordingly, the tension applied to the non-woven fabric during the fibrillation process when the first polymer, i.e., the sea component, is eluted is preferably decreased. As such, the batch manner shown in FIG. 2 or 3 is used rather than the continuous manner shown in FIG. 1.

More specifically, as shown in FIG. 2 or 3, a part of the non-woven fabric 1 is immersed in a predetermined amount of solvent 100 contained in a tank 200, the remaining part of the non-woven fabric 1 is not immersed in the solvent 100, and the non-woven fabric rotates. As a result, immersion and non-immersion of the non-woven fabric 1 in the solvent 100 are repeated and, as a result, the sea component is eluted from the non-woven fabric 1.

As such, the present invention utilizes a batch manner in which the non-woven fabric 1 rotates in the tank 200, rather than a continuous manner in which the non-woven fabric 1 is moved from one direction to another direction as shown in FIG. 1. As a result, high tension is not applied to the non-woven fabric 1 and, as a result, deformation of the non-woven fabric 1 is not serious.

The non-woven fabric 1 is wound on two rollers 300a and 300b and rotates clockwise or counterclockwise in the tank 200. The rollers 300a and 300b include a driving roller 300a driven by a driving member (not shown) and a guide roller 300b which is not driven and guides rotation of the non-woven fabric 1. In this case, the rotation force of the driving roller 300a enables the non-woven fabric 1 to rotate.

Deformation of the non-woven fabric 1 mainly occurs during elution of the sea component from the non-woven fabric 1. The elution of sea component from the non-woven fabric 1 mainly occurs in a state in which the non-woven fabric 1 is immersed in the solvent 100. For this reason, when the non-woven fabric 1 is immersed in the solvent 100, tension applied to the non-woven fabric 1 is preferably minimized in order to minimize deformation of the non-woven fabric 1. Accordingly, by mounting the rollers 300a and 300b to apply tension to the non-woven fabric 1 in an outer part of the solvent 100, a part of the non-woven fabric 1 immersed in the solvent 100 can be arranged such that the non-woven fabric 1 does not contact the rollers 300a and 300b.

In order to minimize tension applied to the non-woven fabric 1, preferably, the driving roller 300a rotates at a rate of 70 m/min to 110 m/min. That is, when the rotation rate of the driving roller 300a exceeds 110 m/min, tension applied to the non-woven fabric 1 increases and the non-woven fabric 1 may be seriously deformed. When the rotation rate of the driving roller 300a is below 70 m/min, production efficiency may be deteriorated.

In addition, since the tension applied to the non-woven fabric 1 greatly depends on the driving roller 300a, the tension applied to the non-woven fabric 1 can be minimized by suitably arranging the driving roller 300a. That is, FIG. 2 illustrates a case in which the driving roller 300a is arranged only at an uppermost part and the guide roller 300b is arranged at the other part. As shown in FIG. 2, a part of the heavy non-woven fabric 1 immersed in the solvent 100 is raised up by the driving roller 300a arranged in the relatively far uppermost part and higher tension is thus applied to the non-woven fabric 1. On the other hand, FIG. 3 illustrates a case in which, while the non-woven fabric 1 rotates, it first contacts the driving roller, when the non-woven fabric moves from a state of being immersed in a solvent to a state of not being immersed in a solvent. In this case, a part of the heavy non-woven fabric 1 immersed in the solvent 100 is raised by the relatively close driving roller 300a and lower tension is advantageously thus applied to the non-woven fabric 1.

Then, the non-woven fabric composed of ultra micro fibers and impregnated with a polymeric elastomer is napped, dyed and post-treated to complete production of the artificial leather according to the present invention.

### 4. EXAMPLES AND COMPARATIVE EXAMPLES

### Example 1

A polyester copolymer in which polyethylene terephthalate as a main component is copolymerized with 5 mole % of a metal sulfonate-containing polyester unit was melted to prepare a sea component melt solution, polyethylene terephthalate (PET) was melted to prepare an island component melt solution, conjugate spinning was performed using 50% by weight of the sea component melt solution in combination with 50% by weight of the island component melt solution to obtain filaments having a single fiber fineness of 3 denier and containing 16 island components in the cross-section. The filaments were drawn at a drawing ratio of 3.3, crimped such that the number of crimps was 15/inch, heat-set at 60° C. and then cut to 51 mm to prepare staple-type island-in-sea fibers.

Then, the island-in-sea fibers were carded to form a web, and the several webs are foled to form a cross-lapped sheet. Then, a non-woven fabric with a unit weight of 350 g/m² and a thickness of 2.0 mm was produced using a needle punch.

Then, the non-woven fabric was padded with 5% by weight of an aqueous polyvinyl alcohol solution and dried, the dried non-woven fabric was immersed in 10% by weight of a 25° C. polyurethane solution obtained by dissolving polyurethane in dimethylformamide (DMF) as a solvent for 3 minutes, and polyurethane was coagulated in 15% by weight of an aqueous dimethylformamide solution and washed with water to impregnate polyurethane into the non-woven fabric.

Then, the sea component (the polyester copolymer) was eluted from the polyurethane-impregnated non-woven fabric using a batch-type apparatus shown in FIG. 2, only the island component (polyethylene terephthalate (PET)) remained, and thus the fibrilation of the fibers were completed.

Specifically, 5% by weight of an aqueous sodium hydroxide solution was used as the solvent 100 and the driving roller 300a was rotated at a rotation rate of 75 m/min for 30 minutes. Then, the non-woven fabric was separated, washed with water and dried to complete the fibrillation process.

Then, the non-woven fabric was napped using a roughness No. 300 sandpaper such that the final thickness was adjusted to 0.6 mm, dyed in a high-pressure rapid dyeing machine using an acidic dye, set, washed with water, dried and treated with a softening agent and an anti-static agent to obtain an artificial leather.

### Example 2

An artificial leather was obtained in the same manner as in Example 1, except that the driving roller 300a was rotated at a rotation rate of 90 m/min when the polyester copolymer, i.e., the sea component, was eluted in Example 1.

### Example 3

An artificial leather was obtained in the same manner as in Example 1, except that the driving roller 300a was rotated at a rotation rate of 105 m/min when the polyester copolymer, i.e., the sea component, was eluted in Example 1.

### Example 4

An artificial leather was obtained in the same manner as in Example 1, except that island-in-sea fibers were prepared from the island component melt solution using polytrimethylene terephthalate (PTT), the polyester copolymer as the sea component was eluted from the polyurethane-impregnated non-woven fabric using a batch-type apparatus shown in FIG. 3, and only the island component, polyethylene terephthalate (PET), remained, and thus the fibrilation of the fibers were completed.

### Comparative Example 1

An artificial leather was obtained in the same manner as in Example 1, except that the elution of the polyester copolymer, the sea component, was carried out using a continuous-type apparatus shown in FIG. 1 in Example 1. Specifically, 5% by weight of an aqueous sodium hydroxide solution was used as the solvent 10 for the apparatus shown in FIG. 1 and the roller 30 was rotated at a rotation rate of 10 m/min.

### Comparative Example 2

An artificial leather was obtained in the same manner as in Example 1, except that the elution of the polyester copolymer, the sea component, was carried out using a continuous-type apparatus shown in FIG. 1 in Example 1. Specifically, 5% by weight of an aqueous sodium hydroxide solution was used as the solvent 10 for the apparatus shown in FIG. 1 and the roller 30 was rotated at a rotation rate of 20 m/min.

The main process conditions of Examples 1 to 4 and Comparative Examples 1 to 2 are summarized in Table 1 below.

TABLE 1

| | | | | | Rotation |
|---|---|---|---|---|---|
| | Island | | Heat-setting | | rate of |
| | compo- | Drawing | temperature | Elution | roller |
| | nent | ratio | (° C.) | type | (m/min) |
| Ex. 1 | PET | 3.3 | 60 | Batch type | 75 |
| | | | | (FIG. 2) | |
| Ex. 2 | PET | 3.3 | 60 | Batch type | 90 |
| | | | | (FIG. 2) | |
| Ex. 3 | PET | 3.3 | 60 | Batch type | 105 |
| | | | | (FIG. 2) | |
| Ex. 4 | PTT | 3.3 | 60 | Batch type | 75 |
| | | | | (FIG. 3) | |
| Comp. | PET | 3.3 | 60 | Continuous | 10 |
| Ex. 1 | | | | type | |
| | | | | (FIG. 1) | |
| Comp. | PET | 3.3 | 60 | Continuous | 20 |
| Ex. 2 | | | | type | |
| | | | | (FIG. 1) | |

### Example 5

A polyester copolymer in which polyethylene terephthalate as a main component is copolymerized with 5 mole % of a metal sulfonate-containing polyester unit was melted to prepare a sea component melt solution, polyethylene terephthalate (PET) was melted to prepare an island component melt solution, conjugate spinning was performed using 30% by weight of the sea component melt solution in combination with 70% by weight of the island component melt solution to obtain filaments which have a single fiber fineness of 3 denier and contain 16 island components in the cross-section. A tow, a bundle of the filaments, was drawn at a drawing ratio of 2.5, crimped such that the number of crimps was 12/inch, heat-set at 15° C. and then cut to 51 mm to prepare staple-shaped island-in-sea fibers.

Then, the island-in-sea fibers were carded to form a web, and the several webs were folded to form a cross-lapped sheet. Then, a non-woven fabric with a unit weight of 350 g/m², a thickness of 1.1 mm and a width of 1920 mm was produced using a needle punch.

Then, the non-woven fabric was padded with 4.5% by weight of an aqueous polyvinyl alcohol solution and dried, the dried non-woven fabric was immersed in 13% by weight of a polyurethane solution obtained to impregnate polyurethane into the non-woven fabric, the fabric was washed with water to remove DMF and polyvinyl alcohol. At this time, the content of the polyurethane in the non-woven fabric was controlled so that the content of polyurethane in the artificial leather was adjusted to 25% after elution of the sea component in the subsequent process.

Then, the sea component (the polyester copolymer) was eluted from the polyurethane-impregnated non-woven fabric using a batch-type apparatus shown in FIG. 2 and the fibers were micronized from the island component, polyethylene terephthalate (PET). Specifically, 4% by weight of an aqueous sodium hydroxide solution was used as the solvent 100 and the driving roller 300a was rotated at a rotation rate of 75 m/min for 30 minutes. Then, the non-woven fabric was separated, washed with water and dried to complete the fibrillation process.

Then, the non-woven fabric was napped using a roughness No. 300 sandpaper such that the final thickness was adjusted to 0.7 mm, dyed in a high-pressure rapid dyeing machine using an acidic dye, set, washed with water, dried and treated with a softening agent and an anti-static agent to obtain an artificial leather.

### Example 6

An artificial leather was obtained in the same manner as in Example 1, except that the filaments obtained by the conjugate spinning process were drawn at a drawing ratio of 2.7, crimped and then heat-set at 40° C. to prepare island-in-sea fibers in Example 5.

### Example 7

An artificial leather was obtained in the same manner as in Example 1, except that the filaments obtained by the conjugate spinning process were drawn at a drawing ratio of 3.0, crimped and then heat-set at 50° C. to prepare island-in-sea fibers in Example 5.

### Example 8

An artificial leather was obtained in the same manner as in Example 1, except that the filaments obtained by the conjugate spinning process were drawn at a drawing ratio of 3.3, crimped and then heat-set at 60° C. to prepare island-in-sea fibers in Example 5.

### Example 9

An artificial leather was obtained in the same manner as in Example 1, except that polytrimethylene terephthalate (PTT) was melted to prepare an island component melt solution in Example 5.

### Example 10

An artificial leather was obtained in the same manner as in Example 1, except that the filaments obtained by the conjugate spinning process were drawn at a drawing ratio of 2.7, crimped and then heat-set at 40° C. to prepare island-in-sea fibers in Example 9.

### Example 11

An artificial leather was obtained in the same manner as in Example 9, except that the filaments obtained by the conjugate spinning process were drawn at a drawing ratio of 3.0, crimped and then heat-set at 50° C. to prepare island-in-sea fibers in Example 9.

### Example 12

An artificial leather was obtained in the same manner as in Example 9, except that the filaments obtained by the conjugate spinning process were drawn at a drawing ratio of 3.3, crimped and then heat-set at 60° C. to prepare island-in-sea fibers in Example 9.

### Comparative Example 3

An artificial leather was obtained in the same manner as in Example 5, except that the filaments obtained by the conjugate spinning process were drawn at a drawing ratio of 3.6, crimped and then heat-set at 140° C. to prepare island-in-sea fibers in Example 5.

### Comparative Example 4

An artificial leather was obtained in the same manner as in Example 1, except that the filaments obtained by the conjugate spinning process were drawn at a drawing ratio of 2.0, crimped and then heat-set at 15° C. to prepare island-in-sea fibers in Example 5.

### Comparative Example 5

An artificial leather was obtained in the same manner as in Example 9, except that the filaments obtained by the conjugate spinning process were drawn at a drawing ratio of 3.6, crimped and then heat-set at 130° C. to prepare island-in-sea fibers in Example 9.

### Comparative Example 6

An artificial leather was obtained in the same manner as in Example 9, except that the filaments obtained by the conjugate spinning process were drawn at a drawing ratio of 2.0, crimped and then heat-set at 15° C. to prepare island-in-sea fibers in Example 9.

The main process conditions of Examples 5 to 12 and Comparative Examples 3 to 6 are summarized in Table 2 below.

TABLE 2

| | | | | | Rotation |
|---|---|---|---|---|---|
| | Island | | Heat-setting | | rate of |
| | compo- | Drawing | temperature | Elution | roller |
| | nent | ratio | (° C.) | type | (m/min) |
| Ex. 5 | PET | 2.5 | 15 | Batch type | 75 |
| | | | | (FIG. 2) | |
| Ex. 6 | PET | 2.7 | 40 | Batch type | 75 |
| | | | | (FIG. 2) | |
| Ex. 7 | PET | 3.0 | 50 | Batch type | 75 |
| | | | | (FIG. 2) | |
| Ex. 8 | PET | 3.3 | 60 | Batch type | 75 |
| | | | | (FIG. 2) | |
| Ex. 9 | PTT | 2.5 | 15 | Batch type | 75 |
| | | | | (FIG. 2) | |
| Ex. 10 | PTT | 2.7 | 40 | Batch type | 75 |
| | | | | (FIG. 2) | |
| Ex. 11 | PTT | 3.0 | 50 | Batch type | 75 |
| | | | | (FIG. 2) | |
| Ex. 12 | PTT | 3.3 | 60 | Batch type | 75 |
| | | | | (FIG. 2) | |
| Comp. | PET | 3.6 | 140 | Batch type | 75 |
| Ex. 3 | | | | (FIG. 2) | |
| Comp. | PET | 2.0 | 15 | Batch type | 75 |
| Ex. 4 | | | | (FIG. 2) | |
| Comp. | PTT | 3.6 | 130 | Batch type | 75 |
| Ex. 5 | | | | (FIG. 2) | |
| Comp. | PTT | 2.0 | 15 | Batch type | 75 |
| Ex. 6 | | | | (FIG. 2) | |

### 3. EXPERIMENTAL EXAMPLE

Variation Before and after Elution

Variations before and after elution of sea component in the process of producing artificial leathers in accordance with Examples 1 to 4 and Comparative Examples 1 to 2 were measured. The results thus obtained are shown in Table 3 below.

TABLE 3

| | Before elution | | After elution | | Variation (%) | |
|---|---|---|---|---|---|---|
| | (mm) | | (mm) | | Width | Length |
| | Width | Length | Width | Length | (decrease) | (increase) |
| Ex. 1 | 1500 | 205 | 1445 | 213 | 3.7 | 3.9 |
| Ex. 2 | 1500 | 205 | 1465 | 210 | 2.3 | 2.4 |
| Ex. 3 | 1500 | 205 | 1435 | 215 | 4.3 | 4.8 |
| Ex. 4 | 1450 | 210 | 1395 | 220 | 3.8 | 4.8 |
| Comp. | 1500 | 205 | 1345 | 228 | 10.3 | 11.2 |
| Ex. 1 | | | | | | |
| Comp. | 1500 | 205 | 1305 | 238 | 13.0 | 16.1 |
| Ex. 2 | | | | | | |

Measurement of Residual Shrinkage Ratio

The artificial leathers in accordance with Examples 1 to 4, and Comparative Examples 1 to 2 were cut to obtain samples with a width (CMD) of 100 mm and a length (MD) of 100 mm, the samples were stretched by ratios of 30% and 40%, allowed to stand for 10 minutes, un-stretched and allowed to stand for one hour, and a width (CMD) and a length (MD) thereof were measured and residual shrinkage ratio was obtained in accordance with equation 1 above. Tables 4 and 5 are as follows.

TABLE 4

| | Before stretching | | After 30% stretching | | Residual shrinkage | |
|---|---|---|---|---|---|---|
| | (mm) | | (mm) | | ratio (%) | |
| | Width | Length | Width | Length | Width | Length |
| Ex. 1 | 100 | 100 | 116 | 107 | 16 | 7 |
| Ex. 2 | 100 | 100 | 114 | 106 | 14 | 6 |
| Ex. 3 | 100 | 100 | 118 | 109 | 18 | 9 |
| Ex. 4 | 100 | 100 | 119 | 110 | 19 | 10 |
| Comp. | 100 | 100 | 129 | 116 | 29 | 16 |
| Ex. 1 | | | | | | |
| Comp. | 100 | 100 | 140 | 123 | 40 | 23 |
| Ex. 2 | | | | | | |

TABLE 5

| | Before stretching | | After 40% stretching | | Residual shrinkage | |
|---|---|---|---|---|---|---|
| | (mm) | | (mm) | | ratio (%) | |
| | Width | Length | Width | Length | Width | Length |
| Ex. 1 | 100 | 100 | 119 | 111 | 19 | 11 |
| Ex. 2 | 100 | 100 | 117 | 110 | 17 | 10 |
| Ex. 3 | 100 | 100 | 120 | 112 | 20 | 12 |
| Ex. 4 | 100 | 100 | 122 | 113 | 22 | 13 |
| Comp. | 100 | 100 | 135 | 119 | 35 | 19 |
| Ex. 1 | | | | | | |
| Comp. | 100 | 100 | 144 | 125 | 44 | 25 |
| Ex. 2 | | | | | | |

Measurement of Elongation Upon 5 kg Static Loading

With respect to artificial leather samples of Examples 1 to 4 and Comparative Examples 1 to 2, elongation upon 5 kg static loading was measured. The measurement method is as follows.

3 specimens with a width (CMD) of 50 mm and a length (MD) of 250 mm were obtained in longitudinal and horizontal directions and bench marks of 100 mm were drawn in the center of the specimens. The specimens were mounted on a Marten's fatigue tester at a cramp distance of 150 mm and a loading of 49N (5 kgf, including a loading of lower cramps) was slowly applied. The loading was maintained for minutes and the distance between the bench marks was measured. Static loading elongation was calculated in accordance with Equation 2 below.

Static loading elongation (%)=l1−100 Equation 2

wherein l1 represents a distance between bench marks 10 minutes after application of loading.

The results thus obtained are shown in Table 6 below:

TABLE 6

| | Elongation in | Elongation in |
|---|---|---|
| | machine direction | cross-machine |
| | (%) | direction (%) |
| Ex. 1 | 25 | 63 |
| Ex. 2 | 22 | 55 |
| Ex. 3 | 26 | 67 |
| Ex. 4 | 33 | 72 |
| Comp. | 16 | 83 |
| Ex. 1 | | |
| Comp. | 13 | 90 |
| Ex. 2 | | |

### Elongation and Tensile Strength of Island-in-Sea Fibers

The elongation and tensile strength of island-in-sea fibers of Examples 5 to 12 and Comparative Examples 3 to 6 were measured. The elongation and tensile strength were obtained by applying 50 mg of preliminary tension to the fibers using Vibroskop (manufactured by Lenzing Instruments GmbH & Co KG), measuring denier thereof, applying 100 mg of preliminary tension thereto, measuring tensile strength with a tensile strength tester (manufactured by Instron corporation) 20 times (length (MD) of the measured sample: 20 mm, tension rate: 100 mm/min) and obtaining an average of the 20 values. The results are shown in Table 7 below.

Measurement of Crystallinity of Island-in-Sea Fibers

The crystallinity of island-in-sea fibers of Examples 5 to 12 and Comparative Examples 3 to 6 were measured. The crystallinity of island-in-sea fibers was calculated in accordance with the following Equation 3 using a theoretical density (ρ_{c}=1.457 g/cm²) of a perfect crystal region of polyester and a density (ρₐ=1.336 g/cm²) of a non-crystal (amorphous) region, based on a sample density (ρ).

$$Crystallinity [ Xc ( \% ) ] = \frac{ρ - {ρ}_{a}}{{ρ}_{c} - {ρ}_{a}} \times 100 \qquad Equation 3$$

At this time, the density of samples was obtained by adding island-in-sea fibers to a densimeter (Model SS, made in Shibayama, Japan) containing a mixed solvent of normal-heptane and carbon tetrachloride, allowing to stand at 23° C. for one day and measuring the density of island-in-sea fibers, in which a sea component is mixed with an island component, in bulk. The results thus obtained are shown in Table 7 below.

Measurement of Elongation and Tensile Strength of Artificial Leathers

The elongation and tensile strength of the artificial leathers of Examples 5 to 12 and Comparative Examples 3 to 6 were measured. The elongation and tensile strength of the artificial leathers were obtained by measuring tensile strength of the artificial leathers with a tensile strength tester (manufactured by Instron corporation) 10 times (length (MD) of the measured sample: 50 mm, tension rate: 300 mm/min) and obtaining an average of the 10 values. The results are shown in Table 7 below.

Measurement of Crystallinity of Artificial Leathers

The crystallinity of artificial leathers of Examples 5 to 12 and Comparative Examples 3 to 6 were measured. The crystallinity of artificial leathers was measured as follows. Polyurethane contained in the artificial leathers was immersed in a dimethylformamide solution at room temperature for 2 hours, the polyurethane was washed with 30° C. distilled water to remove the same, the residue was dried at room temperature for one day and crystallinity of the resulting sample was measured in the same manner as the method for measuring crystallinity of island-in-sea fibers. The results are shown in Table 7 below.

TABLE 7

| | Island-in-sea fiber | | | Artificial leather | | |
|---|---|---|---|---|---|---|
| | | | Tensile | | Elongation (%) | Tensile strength |
| | Crystallinity | Elongation | strength | Crystallinity | (length × | (Kg/cm) |
| | (%) | (%) | (g/d) | (%) | width) | (length × width) |
| Ex. 1 | 25.0 | 130.6 | 3.08 | 26.8 | 27 × 78 | 1.8 × 2.6 |
| Ex. 2 | 26.8 | 117.6 | 3.21 | 29.0 | 25 × 67 | 2.1 × 2.9 |
| Ex. 3 | 28.3 | 108.1 | 3.45 | 30.2 | 23 × 55 | 2.4 × 3.2 |
| Ex. 4 | 30.2 | 93.8 | 3.60 | 32.4 | 19 × 45 | 2.8 × 3.6 |
| Ex. 5 | 23.7 | 145.5 | 2.78 | 25.2 | 33 × 85 | 1.5 × 2.3 |
| Ex. 6 | 25.4 | 131.2 | 3.05 | 27.0 | 31 × 72 | 1.7 × 2.5 |
| Ex. 7 | 27.3 | 122.2 | 3.23 | 29.5 | 29 × 63 | 2.1 × 2.8 |
| Ex. 8 | 29.2 | 107.6 | 3.37 | 30.8 | 24 × 54 | 2.4 × 3.1 |
| Comp. | 34.0 | 64.3 | 3.78 | 34.6 | 17 × 32 | 3.0 × 3.8 |
| Ex. 1 | | | | | | |
| Comp. | 21.0 | 165.4 | 2.65 | 23.5 | 37 × 92 | 1.3 × 1.8 |
| Ex. 2 | | | | | | |
| Comp. | 32.5 | 79.3 | 3.56 | 33.9 | 24 × 60 | 2.6 × 3.2 |
| Ex. 3 | | | | | | |
| Comp. | 19.8 | 190.8 | 2.34 | 22.5 | 44 × 102 | 1.1 × 1.6 |
| Ex. 4 | | | | | | |

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. An artificial leather comprising a non-woven fabric composed of ultra micro fibers and impregnated with an polymeric elastomer, wherein a residual shrinkage ratio of the artificial leather at 30% stretching is 10% or less in a machine direction and is 20% or less in a cross-machine direction.

2. The artificial leather according to claim 1, wherein the residual shrinkage ratio of the artificial leather at 40% stretching is 13% or less in a machine direction and is 25% or less in a cross-machine direction.

3. The artificial leather according to claim 1, wherein an elongation of the artificial leather upon 5 kg of static loading is 20 to 40% in a machine direction and is 40 to 80% in a cross-machine direction.

4. The artificial leather according to claim 1, wherein the artificial leather has a crystallinity of 25 to 33%.

5. The artificial leather according to claim 1, wherein the polymeric elastomer is present in an amount of 15 to 35% by weight.

6. The artificial leather according to claim 1, wherein the ultra micro fiber comprises polyethylene terephthalate, polytrimethylene terephthalate or polybutylene terephthalate, and the polymeric elastomer comprises polyurethane.

7. The artificial leather according to claim 1, wherein the ultra micro fiber has a fineness of 0.3 denier or less.

8. A method for producing an artificial leather, comprising:
preparing an island-in-sea fiber consisting of a first polymer and a second polymer that have different dissolution properties with respect to a solvent;
producing a non-woven fabric with the island-in-sea fiber;
immersing the non-woven fabric in a polymeric elastomer solution to impregnate the polymeric elastomer in the non-woven fabric; and
removing the first polymer which is a sea component from the non-woven fabric,
wherein the removing the first polymer includes rotating the non-woven fabric while immersing a part of the non-woven fabric in a predetermined amount of solvent contained in a tank and not immersing the remainder of the non-woven fabric in the solvent.

9. The method according to claim 8, wherein the rotating the non-woven fabric includes rotating one or more rollers on which the non-woven fabric is wound and during the rotation, a part of the non-woven fabric immersed in the solvent does not contact the roller.

10. The method according to claim 9, wherein the rollers include a driving roller driven by a driving member and a guide roller to guide rotation of the non-woven fabric, wherein the non-woven fabric rotates and first contacts the driving roller, when the non-woven fabric moves from a state of being immersed in a solvent to a state of not being immersed in a solvent.

11. The method according to claim 9, wherein the roller rotates at a rotation rate of 70 m/min to 110 m/min.

12. The method according to claim 8, wherein the preparing the island-in-sea fiber includes:
preparing filaments consisting of a first polymer as a sea component and a second polymer as an island component that have different dissolution properties with respect to a solvent through conjugate spinning;
drawing a tow, a bundle of the filaments, at a drawing ratio of 2.5 to 3.3; and
mounting a crimp on the drawn tow and heat-setting the tow by heating at a predetermined temperature.

13. The method according to claim 12, wherein the heat-setting is carried out at a temperature not lower than 15° C. and not higher than 40° C., when the tow is drawn at a drawing ratio not lower than 2.5 and not higher than 2.7,
the heat-setting is carried out at a temperature higher than 40° C. and not higher than 50° C., when the tow is drawn at a drawing ratio higher than 2.7 and not higher than 3.0, and
the heat-setting is carried out at a temperature higher than 50° C. and not higher than 60° C., when the tow is drawn at a drawing ratio higher than 3.0 and not higher than 3.3.

14. The method according to claim 8, wherein the removing the non-woven fabric is carried out before or after impregnating the polymeric elastomer in the non-woven fabric.

15. An island-in-sea fiber consisting of a first polymer as a sea component and a second polymer as an island component, wherein the first polymer and the second polymer have different dissolution properties with respect to a solvent and the island-in-sea fiber has an elongation of 90 to 150%.

16. The island-in-sea fiber according to claim 15, wherein the island-in-sea fiber has a crystallinity of 23 to 31%.

17. The island-in-sea fiber according to claim 15, wherein the first polymer comprises a polyester copolymer and the second polymer comprises polyethylene terephthalate, polytrimethylene terephthalate, or polybutylene terephthalate.

18. The island-in-sea fiber according to claim 15, wherein the first polymer is present in an amount of 10 to 60% by weight and the second polymer is present in an amount of 40 to 90% by weight.

19. A method for preparing an island-in-sea fiber comprising:
preparing filaments consisting of a first polymer as a sea component and a second polymer as an island component that have different dissolution properties with respect to a solvent through conjugate spinning;
drawing a tow, a bundle of the filaments, at a drawing ratio of 2.5 to 3.3; and
mounting a crimp on the drawn tow and heat-setting the tow by heating at a predetermined temperature.

20. The method according to claim 19, wherein the heat-setting is carried out at a temperature not lower than 15° C. and not higher than 40° C., when the tow is drawn at a drawing ratio not lower than 2.5 and not higher than 2.7,
the heat-setting is carried out at a temperature higher than 40° C. and not higher than 50° C., when the tow is drawn at a drawing ratio higher than 2.7 and not higher than 3.0, and
the heat-setting is carried out at a temperature higher than 50° C. and not higher than 60° C., when the tow is drawn at a drawing ratio higher than 3.0 and not higher than 3.3.
